(19) United States
(12) Patent Application Publication
(10) Pub. No.: US 2011/0172388 A1
(43) Pub. Date: Jul. 14, 2011

(54) EASILY DYEABLE META-TYPE WHOLLY AROMATIC POLYAMIDE FIBER

(75) Inventors: Yusuke Yamauchi, Iwakuni-shi (JP); Kotarou Takiue, Iwakuni-shi (JP)

(73) Assignee: TEIJIN TECHNO PRODUCTS LIMITED, Osaka-shi, Osaka (JP)

(21) Appl. No.: 13/119,544

(22) PCT Filed: Sep. 28, 2009
(86) PCT No.: PCT/JP2009/066789

§ 371 Date: Mar. 17, 2011

(30) Foreign Application Priority Data
Sep. 29, 2008 (JP) 2008-250944

(51) Int. Cl. C08G 69/32

(52) U.S. Cl. 528/348

(57) ABSTRACT

There is provided an easily dyeable meta-type wholly aromatic polyamide fiber excellent in dyeability and acid resistance, and having a very small residual solvent content. The components or conditions of the coagulation bath are appropriately adjusted so as to achieve a coagulated form not having a skin core, plasticization drawing is performed at a specific ratio, and after completing a washing step, a dry heat treatment is performed at a specific temperature.

### TECHNICAL FIELD

The present invention relates to a dyeable meta-type wholly aromatic polyamide fiber. More particularly, it relates to an easily dyeable wholly aromatic meta-type aramid fiber excellent in environmental safety, and also excellent in acid resistance.

### BACKGROUND ART

A meta-type wholly aromatic polyamide fiber such as a polymetaphenylene terephthalamide fiber has a molecular skeleton mostly including aromatic rings, and hence exhibits excellent heat resistance and dimensional stability. By taking advantage of these characteristics, the meta-type wholly aromatic polyamide fiber is preferably used in not only industrial applications but also in applications in which an importance is attached to the heat resistance, flame retardancy, and flame resistance, or other applications. In recent years, it has found rapidly widening applications to the fields of bedding, clothes, interior goods, and the like. Then, particularly in the field of clothes, in addition to the flame resistance and the flame retardancy, further, the dyeability and the acid resistance are also required as the important performances.

However, the meta-type wholly aromatic polyamide fiber is unfavorably difficult to dye with a common method due to the rigid polymer molecule chain.

Under such circumstances, as a method for improving the dyeability, there is proposed a method in which an alkylbenzene sulfonic acid onium salt is added to a spinning solution, thereby to obtain a meta-type aromatic polyamide fiber easily dyeable with respect to a cationic dye (see Patent Literature 1). With this method, it is possible to obtain a meta-type aromatic polyamide fiber having favorable dyeability with respect to a cationic dye.

However, the fiber containing the onium salt added therein is high in cost. Further, in order to prevent the onium salt from falling from the fiber during yarn making, during post-processing, and the like, the coagulation conditions for fiber manufacturing cannot be set severe. As a result, the amount of a solvent remaining in the fiber is large, resulting in inferior environmental safety.

As another method for improving the dyeability, there is proposed the following method. An amorphous fiber having pores is formed, and the fiber swollen with water is vapor heated, so that a dye is diffused into the pores of the fiber. This results in a fiber impregnated with the dye throughout the fiber structure. Subsequently, the fiber is vapor heated over a sufficient time at a higher temperature than the glass transition temperature to collapse the pores. As a result, the dye is confined in the fiber irreversibly to crystallize the fiber (see Patent Literature 2).

With this method, it is possible to obtain a fiber having favorable dyeability, and having a small residual solvent content. However, because of such a heat treatment as to collapse the pores using vapor heated to a temperature of 110° C. to 140° C., fiber crystallization is insufficient, which makes it difficult to obtain favorable acid resistance.

Therefore, there has not yet been obtained a meta-type wholly aromatic polyamide fiber having easy dyeability, which is small in amount of a solvent remaining in the fiber, and has an acid resistance.

### RELATED ART LITERATURE

### Patent Literature

Patent Literature 1: JP-A-08-081827

Patent Literature 2: JP-A-62-184127

### SUMMARY OF THE INVENTION

### Problem that the Invention is to Solve

The present invention was made in view of the background art. It is an object thereof to provide an easily dyeable meta-type wholly aromatic polyamide fiber excellent in dyeability and acid resistance, and with a very small residual solvent content.

### Means for Solving the Invention

The present inventors repeatedly conducted a close study in view of the problem. As a result, they found the following: by appropriately adjusting the components or conditions of the coagulation bath so as to achieve a coagulated form not having a skin core, performing plasticization drawing at a specific ratio, and completing a washing step, and then, performing a dry heat treatment at a specific temperature, the problem can be solved. This has led to the completion of the present invention.

Namely, the invention is an easily dyeable meta-type wholly aromatic polyamide fiber having a residual solvent content of 0.1 mass % or less in the form of the fiber, and having a strength retention ratio of 65% or more in the form of the dyed fiber after 150-hour immersion in a 50° C. 20 mass % aqueous sulfuric acid solution.

### Advantage of the Invention

An easily dyeable meta-type wholly aromatic polyamide fiber of the present invention is favorable in dyeability with respect to a dye, and has both of the excellent acid resistance and environmental safety. For this reason, the industrial value in the fields requiring these characteristics is very large. In the fields in which an importance is attached on the aesthetic property and the visual property, such as bedding, clothes, and interior goods, the fiber can be preferably used.

### MODE FOR CARRYING OUT THE INVENTION

### <Easily Dyeable Meta-Type Wholly Aromatic Polyamide Fiber>

An easily dyeable meta-type wholly aromatic polyamide fiber of the present invention has the following specific physical properties. A description will be given to the physical properties, configuration, manufacturing method, and the like of the easily dyeable meta-type wholly aromatic polyamide fiber of the invention below.

### [Physical Properties of Easily Dyeable Meta-Type Wholly Aromatic Polyamide Fiber]

### [Residual Solvent Content]

The meta-type wholly aromatic polyamide fiber is generally manufactured from a spinning stock solution containing a polymer dissolved in an amide solvent. Accordingly, the solvent is naturally left in the fiber. However, for the meta-type wholly aromatic polyamide fiber of the invention, the amount of the solvent left in the fiber is 0.1 mass % or less based on the mass of the fiber. The amount is essentially 0.1 mass % or less, and more preferably 0.08 mass % or less.

When the solvent is left in the fiber in an amount of more than 0.1 mass % based on the mass of the fiber, during processing or use under a high-temperature atmosphere as high as more than 200° C., the residual solvent vaporizes, resulting in inferior environmental safety. Further, the molecular structure is broken, which undesirably results in a remarkable reduction of the strength.

In the invention, in order to set the residual solvent content of the fiber at 0.1 mass % or less, during the manufacturing step of the fiber, the components or the conditions of the coagulation bath are adjusted so as to achieve a coagulated form not having a skin core, and plasticization drawing is carried out at a specific ratio.

Incidentally, the “residual solvent content of the fiber” in the invention denotes the value obtained in the following manner.

### (Measuring Method of Residual Solvent Content)

About 8.0 g of a fiber is collected, and is dried at 105° C. for 120 minutes. Then, it is allowed to cool in a desiccator to weigh the fiber mass (M1). Subsequently, for the fiber, reflux extraction is carried out in methanol for 1.5 hours by using a Soxhlet extractor. Thus, extraction of the amide solvent contained in the fiber is carried out. The fiber which has completely undergone extraction is taken out, and is vacuum dried at 150° C. for 60 minutes. Then, the fiber is allowed to cool in the desiccator to weigh the fiber mass (M2). The amount of the solvent (amide solvent mass) N (%) remaining in the fiber is calculated using the obtained M1 and M2 from the following equation.

N (%)=[(M1−M2)/M1]×100

### [Strength Retention Ratio of Dyed Fiber]

For the easily dyeable meta-type wholly aromatic polyamide fiber of the invention, the strength retention ratio of the dyed fiber after 150-hour immersion in a 50° C. 20 mass % aqueous sulfuric acid solution is 65% or more. The strength retention ratio is essentially 65% or more, preferably 70% or more, and further preferably 75% or more.

The strength retention ratio of the dyed fiber serves as an indicator of the acid resistance. When the strength retention ratio is less than 65%, the acid resistance when the fiber is used as cloth is insufficient, undesirably resulting in a reduction of the safety.

In the invention, in order to set the strength retention ratio of the dyed fiber at 65% or more, during the manufacturing step of the fiber, the components or the conditions of the coagulation bath are adjusted so as to achieve a coagulated form not having a skin core, and the washing step is completed, and then, a dry heat treatment is carried out at a specific temperature.

Incidentally, the “strength retention ratio” in the invention denotes the value obtainable in the following manner.

### (Method for Determining the Strength Retention Ratio (Acid Resistance Test))

Into a separable flask, a 20 mass % aqueous sulfuric acid solution is charged, and 51 mm of a dyed fiber which has been dyed is immersed therein. Subsequently, the separable flask is immersed in a thermobath, and is held at a temperature of 50° C. The dyed fiber is immersed therein for 150 hours. For the fiber before and after dyeing, the measurement of the tensile strength is carried out to determine the strength retention ratio of the fiber after immersion.

Incidentally, the “tensile strength” in the invention denotes the value obtained from the measurement under the following conditions using model 5565 manufactured by INSTRON Co., according to JIS L 1015.

### (Measurement Conditions)

Grip distance: 20 mm

Initial load: 0.044 cN ( 1/20 g)/dtex

Tensile rate: 20 mm/min

Whereas, the “dyeing” in the invention means dyeing by the following dyeing method unless otherwise specified.

### (Dyeing Method)

There is prepared a dyeing solution containing 6% owf of a cationic dye (trade name: Kayacryl Blue GSL-ED (B-54) manufactured by NIPPON KAYAKU Co., Ltd.), 0.3 mL/L acetic acid, 20 g/L sodium nitrate, 70 g/L benzyl alcohol as a carrier agent, and 0.5 g/L dyeing auxiliary agent (trade name: DISPER TL manufactured by MEISEI CHEMICAL WORKS, Ltd.) as a dispersant. Subsequently, a 60-minute dyeing treatment at 120° C. is carried out with a bath ratio of a fiber and the dyeing solution of 1:40. After the dyeing treatment, using a treatment solution containing 2.0 g/L hydrosulphite, 2.0 g/L AMIRADINE D (trade name AMIRADINE D manufactured by DAI-ICHI KOGYO SEIYAKU CO., Ltd.), and 1.0 g/L sodium hydroxide, in ratios, 20-minute reduction washing at 80° C. is carried out at a bath ratio of 1:20. After washing with water, drying is carried out, resulting in a dyed fiber.

### [Tensile Strength and Elongation at Break of Fiber]

The tensile strength of the fiber (fiber before dyeing) of the easily dyeable meta-type wholly aromatic polyamide fiber of the invention is preferably 2.5 cN/dtex or more. It is further preferably 2.7 cN/dtex or more, and in particular preferably 3.0 cN/dtex or more. When the tensile strength is less than 2.5 cN/dtex, the fiber is broken during the post-processing step such as spinning, and undesirably the passability is deteriorated.

Whereas, the elongation at break of the fiber (fiber before dyeing) of the easily dyeable meta-type wholly aromatic polyamide fiber of the invention is preferably 30% or more. It is further preferably 35% or more, and in particular preferably 40% or more. When the elongation at break is less than 30%, the passability during the post-processing step such as spinning is undesirably deteriorated.

Incidentally, the “tensile strength” and “elongation at break” herein used denotes the values obtained from the measurement under the measurement conditions of the “tensile strength” according to JIS L 1015.

In the invention, the “tensile strength” of the easily dyeable meta-type wholly aromatic polyamide fiber can be controlled by making proper the draw ratio in the plasticization drawing bath drawing step and the heat treatment temperature in the dry heat treatment step in the manufacturing method described later. In order to set the tensile strength at 2.5 cN/dtex or more, it is essential only that the draw ratio is set at 3.5 to 5.0 times, and further, the dry heat temperature is set within the range of 260 to 330° C.

In the invention, the “elongation at break” of the easily dyeable meta-type wholly aromatic polyamide fiber can be controlled by making proper the coagulation bath conditions in the coagulation step in the manufacturing method described later. In order to achieve 30% or more, it is essential only that the coagulation solution is an aqueous solution with an NMP concentration of 45 to 60 mass %, and the temperature of the bath solution is set at 10 to 35° C.

### [Percentage Dye Exhaustion of Dyed Fiber]

As for the easily dyeable meta-type wholly aromatic polyamide fiber of the invention, the percentage dye exhaustion of the dyed fiber dyed by the foregoing dyeing method is preferably 90% or more. The percentage dye exhaustion of the dyed fiber is preferably 90% or more, and further preferably % or more. When the dyed fiber has a percentage dye exhaustion of less than 90%, it is not preferable in terms of the aesthetic property required in the field of clothes. Thus, the dyed fiber cannot be dyed in a desirable hue.

Incidentally, the “percentage dye exhaustion” in the invention denotes the value obtainable in the following manner.

### (Percentage Dye Exhaustion)

To the dye residual solution which has dyed the fiber, dichloromethane in the same volume as that of the dye residual solution is added to extract the residual dye. Subsequently, the extraction solution is measured for the absorbances at wavelengths of 670 nm, 540 nm, and 530 nm, respectively. From the calibration curves at the three wavelengths previously formed from a dichloromethane solution with a known dye concentration, the dye concentrations of the extraction solution are respectively determined. The mean value of the concentrations at the three wavelengths is referred to as the dye concentration (C) of the extraction solution. The value obtainable using the dye concentration before dyeing (Co) from the following equation is referred to as the percentage dye exhaustion (U).

Percentage dye exhaustion (U)=[(Co−C)/Co]×100

In the invention, the percentage dye exhaustion of the dyed fiber of the easily dyeable meta-type wholly aromatic polyamide fiber can be controlled by optimizing the crystallization degree of the fiber in the following manner. In the coagulation step of the manufacturing method described later, the conditions of the coagulation bath is adjusted so as to achieve the coagulated form not having a skin core. In addition, in the dry heat treatment step, a dry heat treatment is carried out at a specific temperature. In order to set the percentage dye exhaustion of the dyed fiber at 90% or more, it is essential only to implement the following: the coagulation solution is an aqueous solution with an NMP concentration of 45 to 60 mass %; the temperature of the bath solution is 10 to 35° C.; and the dry heat treatment temperature is within the range of 260 to 330° C. which is the glass transition temperature (Tg) of the fiber or higher.

### [Configuration of Meta-Type Wholly Aromatic Polyamide]

The meta-type wholly aromatic polyamide forming the easily dyeable meta-type wholly aromatic polyamide fiber of the invention includes a meta-type aromatic diamine component and a meta-type aromatic dicarboxylic acid component. Other copolymerizable components such as para-type ones may be copolymerized therewith within such a range as not to impair the object of the invention.

In particular preferably used ones in the invention are meta-type wholly aromatic polyamides containing a metaphenylene isophthalamide unit as a main component from the viewpoints of the dynamic characteristics and the heat resistance. The meta-type wholly aromatic polyamide including a metaphenylene isophthalamide unit includes the metaphenylene isophthalamide unit in an amount of preferably 90 mol % or more, further preferably 95 mol % or more, and in particular preferably 100 mol % based on the total amount of the repeating units.

### [Raw Material of Meta-Type Wholly Aromatic Polyamide]

### (Meta-Type Aromatic Diamine Component)

As the meta-type aromatic diamine components serving as the raw materials for the meta-type wholly aromatic polyamide, mention may be made of metaphenylene diamine, 3,4′-diaminodiphenyl ether, 3,4′-diaminodiphenylsulfone, and the like, and derivatives having substituents such as halogen, and alkyl groups having 1 to 3 carbon atoms at these aromatic rings, for example, 2,4-toluylenediamine, 2,6-toluylenediamine, 2,4-diaminochlorobenzene, and 2,6-diaminochlorobenzene. Out of these, metaphenylene diamine alone, or a mixed diamine containing metaphenylene diamine in an amount of 85 mol % or more, preferably 90 mol % or more, and in particular preferably 95% or more are preferred.

### (Meta-Type Aromatic Carboxylic Acid Component)

As the meta-type aromatic dicarboxylic acid component serving as the raw material for the meta-type wholly aromatic polyamide, for example, mention may be made of meta-type aromatic dicarboxylic acid halides. As the meta-type aromatic dicarboxylic acid halides, mention may be made of isophthalic acid halides such as isophthalic acid chloride and isophthalic acid bromide, and derivatives having substituents such as halogen, and alkoxy groups having 1 to 3 carbon atoms at these aromatic rings, for example, 3-chloroisophthalic acid chloride. Out of these, isophthalic acid chloride itself, or a mixed carboxylic acid halide containing isophthalic acid chloride in an amount of 85 mol % or more, preferably 90 mol % or more, and in particular preferably 95% or more are preferred.

### [Manufacturing Method of Meta-Type Wholly Aromatic Polyamide]

The manufacturing method of meta-type wholly aromatic polyamide has no particular restriction. For example, manufacturing can be carried out by solution polymerization, interface polymerization, or the like using a meta-type aromatic diamine component and a meta-type aromatic dicarboxylic acid chloride component as raw materials.

### <Manufacturing Method of Meta-Type Wholly Aromatic Polyamide Fiber>

The easily dyeable meta-type wholly aromatic polyamide fiber of the invention is manufactured by using meta-type wholly aromatic polyamide obtained by the foregoing manufacturing method through, for example, a spinning solution preparation step, a spinning/coagulation step, a plasticization drawing bath drawing step, a washing step, a relaxation treatment step, and a heat treatment step, described below.

### [Spinning Solution Preparation Step]

In the spinning solution preparation step, meta-type wholly aromatic polyamide is dissolved in an amide solvent to prepare a spinning solution (meta-type wholly aromatic polyamide polymer solution). For preparation of the spinning solution, in general, an amide solvent is used. As the amide solvents to be used, mention may be made of N-methyl-2-pyrrolidone (NMP), dimethylformamide (DMF), dimethylacetamide (DMAc), and the like. Out of these, NMP or DMAc are preferably used from the viewpoints of the solubility and the handling safety.

As the solution concentration, a proper concentration may be appropriately selected from the viewpoints of the coagulation rate in the spinning/coagulation step which is the next step and the solubility of the polymer. For example, when the polymer is polymetaphenylene isophthalamide, and the solvent is NMP, in general, the concentration is set preferably within the range of 10 to 30 mass %.

### [Spinning/Coagulation Step]

In the spinning/coagulation step, the spinning solution (meta-type wholly aromatic polyamide polymer solution) obtained above is spun out in a coagulation solution, and is coagulated.

The spinning device has no particular restriction. Conventionally known wet spinning devices are usable. Further, the device is not required to have a particular restriction on the number of spinning holes, the array state, and the hole shape of the spinneret, and the like so long as it can perform wet spinning with stability. For example, there may be used a multi-hole spinneret for spun rayon with of 500 to 30000 holes and a spinning hole diameter of 0.05 to 0.2 mm.

Whereas, the temperature of the spinning solution (meta-type wholly aromatic polyamide polymer solution) when the spinning solution is spun out from the spinneret is properly within the range of 10 to 90° C.

As the coagulation bath to be used for obtaining the fiber of the invention, an aqueous solution not containing an inorganic salt, and having an NMP concentration of 45 to 60 mass % is used at a bath solution temperature within the range of 10 to 35° C. An NMP concentration of less than 45 mass % results in a thick skin structure, which reduces the washing efficiency in the washing step. This results in a difficulty in setting the residual solvent content of the fiber at 0.1 mass % or less. Whereas, when the NMP concentration exceeds 60 mass %, uniform coagulation cannot be carried out to the fiber inside. This results in a difficulty in setting the residual solvent content of the fiber at 0.1 mass % or less, and further results in an insufficient acid resistance. Incidentally, the immersion time of the fiber in the coagulation bath is properly within the range of 0.1 to 30 seconds.

In the invention, by setting the components or the conditions of the coagulation bath as described above, it is possible to reduce the thickness of the skin formed on the fiber surface, and achieve a structure uniform through the fiber inside. As a result, it is possible to more improve the dyeability and the acid resistance, and further to improve the elongation at break of the resulting fiber.

### [Plasticization Drawing Bath Drawing Step]

In the plasticization drawing bath drawing step, while the fiber obtained from coagulation in the coagulation bath is in a plasticized state, the fiber is subjected to a drawing treatment in a plasticization drawing bath.

The plasticization drawing bath solution has no particular restriction. Conventionally known bath solution can be adopted.

In order to obtain the fiber of the invention, the draw ratio in the plasticization drawing bath is required to be set within the range of 3.5 to 5.0 times, and further preferably within the range of 3.7 to 4.5 times. In the invention, by carrying out plasticization drawing within the range of specific ratios in a plasticization drawing bath, it is possible to promote desolvation from the coagulated yarn. As a result, the residual solvent content of the fiber can be set at 0.1 mass % or less.

When the plasticized draw ratio in the plasticization drawing bath is less than 3.5 times, desolvation from the coagulated yarn becomes insufficient. As a result, it becomes difficult to set the residual solvent content of the fiber at 0.1 mass % or less. Further, the tensile strength becomes insufficient, resulting in a difficulty in handling in processing steps such as a spinning step. On the other hand, when the draw ratio exceeds 5.0 times, single yarn breakage occurs, so that the production stability is deteriorated.

The temperature of the plasticization drawing bath is preferably within the range of 10 to 90° C. When the temperature is preferably within the range of 10 to 90° C., the step condition is good.

### [Washing Step]

In the washing step, the fiber drawn in the plasticization drawing bath is sufficiently washed. Washing affects the aspect of the quality of the resulting fiber, and hence is preferably carried out in multi-steps. Particularly, the temperature of the washing bath in the washing step and the concentration of the amide solvent in the washing solution affect the extraction state of the amide solvent from the fiber and the penetration state of water from the washing bath into the fiber. For this reason, also in terms of the aim of rendering these in the optimum states, preferably, the washing step is in multi-steps, and the temperature conditions and the concentration conditions of the amide solvent are controlled.

The temperature conditions and the concentration conditions of the amide solvent have no particular restriction so long as they can satisfy the quality of the finally obtainable fiber. However, when the first washing bath is set at a temperature as high as 60° C. or more, penetration of water into the fiber occurs at a time. Accordingly, a huge void is formed in the fiber, which entails deterioration of the quality. For this reason, the first washing bath is preferably set at a temperature as low as 30° C. or less.

When a solvent is left in the fiber, the environmental safety in processing of products using the fiber, and use of products formed using the fiber is undesirable. For this reason, the amount of the solvent contained in the fiber of the invention is 0.1 mass % or less, and further preferably 0.08 mass % or less.

### [Dry Heat Treatment Step]

In the dry heat treatment step, the fiber which has undergone the washing step is dried/heat treated. The method of the dry heat treatment has no particular restriction. However, for example, mention may be made of a method using a heat roller, a hot plate, or the like. By completing the dry heat treatment, the easily dyeable meta-type wholly aromatic polyamide fiber of the invention can be finally obtained.

In order to obtain the fiber of the invention, the heat treatment temperature in the dry heat treatment step is required to be set within the range of 260 to 330° C., and further preferably to be set within the range of 270 to 310° C. When the heat treatment temperature is less than 260° C., crystallization of the fiber becomes insufficient. Accordingly, the objective acid resistance becomes insufficient. On the other hand, in the case of more than 330° C., the crystallization of the fiber occurs too much. Accordingly, the dyeability is largely reduced. Further, setting of the dry heat treatment temperature within the range of 260 to 330° C. contributes to the improvement of the tensile strength of the resulting fiber.

### EXAMPLES

Below, the present invention will be more specifically described by way of Examples and the like, which should not be construed as limiting the scope of the invention.

### <Measuring Method>

Respective physical property values in Examples and Comparative Examples were measured in the following manner.

### [Fineness]

Measurements in accordance with the method A of the fineness based on corrected mass were carried out according to JIS L 1015, and the value is expressed in terms of the apparent fineness.

### [Tensile Strength, Elongation at Break]

Measurements were carried out by means of model 5565 manufactured by INSTRON Co., according to JIS L 1015, under the following conditions:

### (Measurement Conditions)

Grip distance: 20 mm

Initial load: 0.044 cN ( 1/20 g)/dtex

Tensile rate: 20 mm/min

### [Percentage Dye Exhaustion]

To the dye residual solution which has dyed the fiber, dichloromethane in the same volume as that of the dye residual solution is added to extract the residual dye. Subsequently, the extraction solution is measured for the absorbances at wavelengths of 670 nm, 540 nm, and 530 nm, respectively. From the calibration curves at the three wavelengths previously formed from a dichloromethane solution with a known dye concentration, the dye concentrations of the extraction solution are respectively determined. The mean value of the concentrations at the three wavelengths is referred to as the dye concentration (C) of the extraction solution. The value obtainable using the dye concentration before dyeing (Co) from the following equation is referred to as the percentage dye exhaustion (U).

Percentage dye exhaustion (U)=[(Co−C)/Co]×100

### [Strength Retention Ratio (Acid Resistance Test)]

Into a separable flask, a 20 mass % aqueous sulfuric acid solution is charged, and 51 mm of a dyed fiber which has been dyed is immersed therein. Subsequently, the separable flask is immersed in a thermobath, and is held at a temperature of 50° C. The dyed fiber is immersed therein for 150 hours. For the fiber before and after dyeing, the measurement of the tensile strength is carried out by the measuring method to determine the strength retention ratio of the fiber after immersion.

### [Residual Solvent Content of Fiber]

A fiber was collected in an amount of about 8.0 g, and was dried at 105° C. for 120 minutes. Then, the fiber was allowed to cool in a desiccator to weigh the fiber mass (M1). Subsequently, for the fiber, reflux extraction was carried out in methanol for 1.5 hours by using a Soxhlet extractor. Thus, extraction of the amide solvent contained in the fiber was carried out. The fiber which has completely undergone extraction was taken out, and was vacuum dried at 150° C. for 60 minutes. Then, the fiber was allowed to cool in the desiccator to weigh the fiber mass (M2). The amount of the solvent (amide solvent mass) N (%) remaining in the fiber was calculated using the obtained M1 and M2 from the following equation.

N (%)=[(M1−M2)/M1]×100

### Example 1

### [Spinning Solution Preparation Step]

A polymetaphenylene isophthalamide powder with an intrinsic viscosity (I. V.) of 1.9, manufactured by an interface polymerization method according to the method described in JP-B-47-10863 was suspended in an amount of 20.0 parts by mass into 80.0 parts by mass of N-methyl-2-pyrrolidone (NMP) cooled to −10° C., to be in a slurry form. Subsequently, the suspension was heated to 60° C. for dissolution, resulting in a transparent polymer solution A.

### [Spinning/Coagulation Step]

The polymer solution A was discharged as a spinning stock solution through a spinneret with a hole diameter of 0.07 mm and with 500 holes into a coagulation bath at a bath temperature of 30° C. for spinning. The coagulation solution had a composition of water/NMP=45/55 (parts by mass), and was discharged into the coagulation bath at a yarn speed of 7 m/min for spinning.

### [Plasticization Drawing Bath Drawing Step]

Subsequently, drawing was carried out at a draw ratio of 3.7 times in the plasticization drawing bath of a composition of water at a temperature of 40° C./NMP=45/55.

### [Washing Step]

After drawing, washing was carried out in a bath (immersion length 1.8 m) of 20° C. water/NMP=70/30, and subsequently, in a 20° C. water bath (immersion length 3.6 m). Further, washing was sufficiently carried out through a 60° C. warm water bath (immersion length 5.4 mm).

### [Dry Heat Treatment Step]

The fiber after washing was subjected to a dry heat treatment by means of a heat roller with a surface temperature of 280° C., resulting in a meta-type wholly aromatic aramid fiber.

### [Physical Properties of Fiber]

The resulting fiber had physical properties of a fineness of 1.7 dtex, a tensile strength of 2.8 cN/dtex, an elongation at break of 51.0%, and a residual solvent content of 0.08 mass %, and showed favorable dynamic characteristics. The physical properties of the resulting fiber are shown in Table 1.

### [Dyeing Step]

There was prepared a dyeing solution containing 6% owf of a cationic dye (trade name: Kayacryl Blue GSL-ED (B-54) manufactured by NIPPON KAYAKU Co., Ltd.), 0.3 mL/L acetic acid, 20 g/L sodium nitrate, 70 g/L benzyl alcohol as a carrier agent, and 0.5 g/L dyeing auxiliary agent (trade name: DISPER L manufactured by MEISEI CHEMICAL WORKS, Ltd.) as a dispersant. A sample fiber in a tow state was subjected to a dyeing treatment at 120° C. for 60 minutes with a bath ratio of the fiber and the dyeing solution of 1:40. After the dyeing treatment, using a treatment solution containing 2.0 g/L hydrosulphite, 2.0 g/L AMIRADINE D (trade name AMIRADINE D manufactured by DAI-ICHI KOGYO SEIYAKU CO., Ltd.), and 1.0 g/L sodium hydroxide, in ratios, 20-minute reduction washing at 80° C. was carried out at a bath ratio of 1:20. After washing with water, drying was carried out, resulting in a dyed fiber.

### [Physical Properties of Dyed Fiber and the Like]

The percentage dye exhaustion of the dyed fiber was 92.4%, and favorable dyeability was shown. Further, the tensile strength of the dyed fiber was 2.9 cN/dtex, and the tensile strength of the dyed fiber after carrying out the acid resistance test was 1.9 cN/dtex, and the strength retention ratio was 66%. Thus, favorable acid resistance was shown. The physical properties of the resulting fiber are shown in Table 1.

### Example 2

### [Spinning Solution Preparation Step]

Into a reaction container equipped with a stirring device and a raw material charging port, 854.8 parts of N-methyl-2-pyrrolidone (which will be hereinafter abbreviated as NMP) was charged. Into the NMP, 83.4 parts of metaphenylene diamine (which will be hereinafter abbreviated as MPDA) was dissolved. Further, to the solution, 156.9 parts of isophthalic acid chloride (which will be hereinafter abbreviated as IPC) was gradually added with stirring to effect the reaction. Stirring was continued for 40 minutes from the start of the reaction. Then, 57.1 parts of a calcium hydroxide power was added. Further, stirring was performed for another minutes. then, the reaction was terminated. The polymerization solution was taken out from the reaction container. As a result, the polymerization solution was transparent, and the polymer concentration was 16%.

### [Spinning/Coagulation Step, Plasticization Drawing Bath Drawing Step, Washing Step, Water Vapor Relaxation Heat Treatment Step, Dry Heat Treatment Step]

A polymetaphenylene isophthalamide fiber was obtained in the same manner as in Example 1, except that the resulting polymerization solution was used as a spinning stock solution, the draw ratio in the plasticization drawing bath was set at 3.5 times, and the surface temperature in the dry heat treatment step was set at 310° C.

### [Physical Properties of Fiber]

The resulting fiber had physical properties of a fineness of 1.7 dtex, a tensile strength of 3.2 cN/dtex, an elongation at break of 45.3%, and a residual solvent content of 0.10 mass %. The physical properties of the resulting fiber are shown in Table 1.

### [Dyeing Step]

The resulting fiber was subjected to a dyeing step in the same manner as in Example 1.

### [Physical Properties of Dyed Fiber and the Like]

The percentage dye exhaustion was 91.0%, and favorable dyeability was shown. Further, the tensile strength of the dyed fiber was 3.2 cN/dtex, and the tensile strength of the dyed fiber after carrying out the acid resistance test was 2.4 cN/dtex, and the strength retention ratio was 75%. Thus, favorable acid resistance was shown. The physical properties of the resulting fiber are shown in Table 1.

### Example 3

### [Manufacturing of Fiber]

A polymetaphenylene isophthalamide fiber was obtained in the same manner as in Example 2, except that the draw ratio in the plasticization drawing bath was set at 4.5 times, and the surface temperature in the dry heat treatment step was set at 280° C.

### [Physical Properties of Fiber]

The resulting fiber had physical properties of a fineness of 1.7 dtex, a tensile strength of 3.6 cN/dtex, an elongation at break of 36.1%, and a residual solvent content of 0.06 mass %. The physical properties of the resulting fiber are shown in Table 1.

### [Dyeing Step]

The resulting fiber was subjected to a dyeing step in the same manner as in Example 1.

### [Physical Properties of Dyed Fiber and the Like]

The percentage dye exhaustion was 91.5%, and favorable dyeability was shown. Further, the tensile strength of the dyed fiber was 3.5 cN/dtex, and the tensile strength of the dyed fiber after carrying out the acid resistance test was 2.5 cN/dtex, and the strength retention ratio was 71%. Thus, favorable acid resistance was shown. The physical properties of the resulting fiber are shown in Table 1.

### Example 4

### [Manufacturing of Fiber]

A polymetaphenylene isophthalamide fiber was obtained in the same manner as in Example 3, except that the coagulation solution composition was set at water/NMP=55/45 in the spinning/coagulation step.

### [Physical Properties of Fiber]

The resulting fiber had physical properties of a fineness of 1.7 dtex, a tensile strength of 3.7 cN/dtex, an elongation at break of 32.0%, and a residual solvent content of 0.05 mass %.

### [Dyeing Step]

The resulting fiber was subjected to a dyeing step in the same manner as in Example 1.

### [Physical Properties of Dyed Fiber and the Like]

The percentage dye exhaustion was 90.4%, and favorable dyeability was shown. Further, the tensile strength of the dyed fiber was 3.7 cN/dtex, and the tensile strength of the dyed fiber after carrying out the acid resistance test was 2.7 cN/dtex, and the strength retention ratio was 73%. Thus, favorable acid resistance was shown. The physical properties of the resulting fiber are shown in Table 1.

### Comparative Example 1

### [Manufacturing of Fiber]

A polymetaphenylene isophthalamide fiber was obtained in the same manner as in Example 2, except that the coagulation solution composition was set at water/NMP=70/30 in the spinning/coagulation step, the draw ratio in the plasticization drawing bath was set at 3.7 times, and the surface temperature in the dry heat treatment step was set at 280° C.

### [Physical Properties of Fiber]

The resulting fiber had physical properties of a fineness of 1.7 dtex, a tensile strength of 2.5 cN/dtex, an elongation at break of 25.0%, and a residual solvent content of 0.30 mass %. The physical properties of the resulting fiber are shown in Table 1.

### [Dyeing Step]

The resulting fiber was subjected to a dyeing step in the same manner as in Example 1.

### [Physical Properties of Dyed Fiber and the Like]

The tensile strength of the dyed fiber was 2.6 cN/dtex, and the tensile strength of the dyed fiber after carrying out the acid resistance test was 1.8 cN/dtex, and the strength retention ratio was 69%. Thus, favorable results were shown. However, the percentage dye exhaustion was 85.3%, thus indicating an insufficient result. The physical properties of the resulting fiber are shown in Table 1.

### Comparative Example 2

A polymetaphenylene isophthalamide fiber was obtained in the same manner as in Example 2, except that the coagulation solution composition was set at water/NMP=30/70 in the spinning/coagulation step, the draw ratio in the plasticization drawing bath was set at 3.7 times, and the surface temperature in the dry heat treatment step was set at 280° C.

### [Physical Properties of Fiber]

The resulting fiber had physical properties of a fineness of 1.7 dtex, a tensile strength of 2.4 cN/dtex, an elongation at break of 28.0%, and a residual solvent content of 0.60 mass %. The physical properties of the resulting fiber are shown in Table 1.

### [Dyeing Step]

The resulting fiber was subjected to a dyeing step in the same manner as in Example 1.

### [Physical Properties of Dyed Fiber and the Like]

The percentage dye exhaustion was 94.0%, thus indicating favorable dyeability. However, the tensile strength of the dyed fiber was 2.4 cN/dtex, and the tensile strength of the dyed fiber after carrying out the acid resistance test was 1.2 cN/dtex, and the strength retention ratio was 50%, thus indicating a poor result in terms of the acid resistance.

### Comparative Example 3

### [Manufacturing of Fiber]

A polymetaphenylene isophthalamide fiber was obtained by forming a spinning stock solution in the same manner as in Example 2, and in the same manner as in Example 2, except that the draw ratio in the plasticization drawing bath was set at 3.0 times, and the surface temperature in the dry heat treatment step was set at 280° C.

### [Physical Properties of Fiber]

The resulting fiber had physical properties of a fineness of 1.7 dtex, a tensile strength of 2.2 cN/dtex, an elongation at break of 55.3%, and a residual solvent content of 0.60 mass %. The physical properties of the resulting fiber are shown in Table 1.

### [Dyeing Step]

The resulting fiber was subjected to a dyeing step in the same manner as in Example 1.

### [Physical Properties of Dyed Fiber and the Like]

The percentage dye exhaustion was 93.8%, thus indicating favorable dyeability. However, the tensile strength of the dyed fiber was 2.2 cN/dtex, and the tensile strength of the dyed fiber after carrying out the acid resistance test was 1.2 cN/dtex, and the strength retention ratio was 55%, thus indicating a poor result in terms of the acid resistance.

### Comparative Example 4

### [Manufacturing of Fiber]

Manufacturing of a polymetaphenylene isophthalamide fiber was attempted in the same manner as in Example 2, except that the draw ratio in the plasticization drawing bath was set at 5.5 times, and the surface temperature in the dry heat treatment step was set at 280° C. However, the step condition was bad, resulting in a difficulty in collecting the fiber with stability for a long time.

### Comparative Example 5

### [Manufacturing of Fiber]

A polymetaphenylene isophthalamide fiber was obtained in the same manner as in Example 2, except that the draw ratio in the plasticization drawing bath was set at 3.7 times, and the surface temperature in the dry heat treatment step was set at 220° C.

### [Physical Properties of Fiber]

The resulting fiber had physical properties of a fineness of 1.7 dtex, a tensile strength of 2.6 cN/dtex, an elongation at break of 53.0%, and a residual solvent content of 0.08 mass %. The physical properties of the resulting fiber are shown in Table 1.

### [Dyeing Step]

The resulting fiber was subjected to a dyeing step in the same manner as in Example 1.

### [Physical Properties of Dyed Fiber and the Like]

The percentage dye exhaustion was 94.8%, thus indicating favorable dyeability. However, the tensile strength of the dyed fiber was 2.7 cN/dtex, and the tensile strength of the dyed fiber after carrying out the acid resistance test was 1.2 cN/dtex, and the strength retention ratio was 44%, thus indicating a poor result in terms of the acid resistance.

TABLE 1

| | | | | | | Comp. | Comp. | Comp. | Comp. | Comp. |
|---|---|---|---|---|---|---|---|---|---|---|
| | | Ex. 1 | Ex. 2 | Ex. 3 | Ex. 4 | Ex. 1 | Ex. 2 | Ex. 3 | Ex. 4 | Ex.5 |
| Coagulation bath NMP composition (water/NMP) | | 45/55 | 45/55 | 45/55 | 55/45 | 70/30 | 30/70 | 45/55 | 45/55 | 45/55 |
| Draw ratio in plasticization bath (times) | | 3.7 | 3.5 | 4.5 | 4.5 | 3.7 | 3.7 | 3.0 | 5.5 | 3.7 |
| Dry heat treatment temperature (° C.) | | 280 | 310 | 280 | 280 | 280 | 280 | 280 | 280 | 220 |
| Physical properties of | Fineness (dtex) | 1.7 | 1.7 | 1.7 | 1.7 | 1.7 | 1.7 | 1.7 | — | 1.7 |
| fiber | Tensile strength (cN/dtex) | 2.8 | 3.2 | 3.6 | 3.7 | 2.5 | 2.4 | 2.2 | — | 2.6 |
| | Elongation at break (%) | 51.0 | 45.3 | 36.1 | 32.0 | 25.0 | 28.0 | 55.3 | — | 53.0 |
| | Residual solvent content (%) | 0.08 | 0.10 | 0.06 | 0.05 | 0.30 | 0.60 | 0.60 | — | 0.08 |
| Physical properties of | Percentage dye exhaustion | 92.4 | 91.0 | 91.5 | 90.4 | 85.3 | 94.0 | 93.8 | — | 94.8 |
| dyed fiber | (%) | | | | | | | | | |
| | Tensile strength (cN/dtex) | 2.9 | 3.2 | 3.5 | 3.7 | 2.6 | 2.4 | 2.2 | — | 2.7 |
| After carrying out acid | Tensile strength (cN/dtex) | 1.9 | 2.4 | 2.5 | 2.7 | 1.8 | 1.2 | 1.2 | — | 1.2 |
| resistance test | | | | | | | | | | |
| Strength retention ratio | Strength retention ratio (%) | 66 | 75 | 71 | 73 | 69 | 50 | 55 | — | 44 |

### INDUSTRIAL APPLICABILITY

An easily dyeable meta-type wholly aromatic polyamide fiber of the present invention is a fiber which is excellent in dyeability and acid resistance, and is very small in residual solvent content of the fiber, and is excellent in environmental safety. For this reason, the industrial value of this fiber is very large in the fields requiring these characteristics. In the fields in which an importance is attached on the aesthetic property and the visual property, such as bedding, clothes, and interior goods, products excellent in safety can be obtained, and hence the utility is very large.

1. An easily dyeable meta-type wholly aromatic polyamide fiber having a residual solvent content of 0.1 mass % or less in the form of the fiber, and having a strength retention ratio of 65% or more in the form of the dyed fiber after 150-hour immersion in a 50° C. 20 mass % aqueous sulfuric acid solution.

2. The easily dyeable meta-type wholly aromatic polyamide fiber according to claim 1, wherein the percentage dye exhaustion of the dyed fiber is 90% or more.
